(19) United States
(12) Patent Application Publication
(10) Pub. No.: US 2026/0024019 A1
(43) Pub. Date: Jan. 22, 2026

(54) GENERATING ROTATIONALLY INVARIANT OR COVARIANT DESCRIPTORS OF CONFIGURATIONS OF POINTS

(71) Applicant: GDM Holding LLC, Mountain View, CA (US)

(72) Inventors: Hartmut Maennel, Zurich (CH); Oliver Thorsten Unke, Berlin (DE); Klaus-Robert Müller, Berlin (DE)

(21) Appl. No.: 19/273,791

(22) Filed: Jul. 18, 2025

Related U.S. Application Data
(60) Provisional application No. 63/673,556, filed on Jul. 19, 2024.

(51) Int. Cl. G06N 20/00; G06F 17/16

(52) U.S. Cl. CPC G06N 20/00; G06F 17/16

(57) ABSTRACT

Methods, systems, and apparatus, including computer programs encoded on a computer storage medium for generating rotationally invariant or covariant descriptors of a three-dimensional configuration of points. In one aspect, a method comprises: using coordinates of the points to determine a plurality of feature vectors, each having a corresponding degree and comprising a respective one or more features, each feature being determined using a spherical harmonic function of the degree of the feature vector and a respective order by combining values of the spherical harmonic function evaluated at the respective coordinates; transforming each of the plurality of the feature vectors into a corresponding moment matrix, wherein each moment matrix corresponds to a respective irreducible representation of the 3D rotation group in a direct sum representation of a tensor product of irreducible representations of the 3D rotation group; and using the moment matrices to determine one or more invariant or covariant descriptors.

### CROSS-REFERENCE TO RELATED APPLICATION

This application claims priority under 35 U.S.C. 119 to Provisional Application No. 63/673,556, filed Jul. 19, 2024, which is incorporated by reference.

### BACKGROUND

This specification relates to generating rotationally invariant or covariant descriptors of configurations of points for processing using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system, and a method, implemented as computer programs on one or more computers in one or more locations, for generating rotationally invariant or covariant descriptors of a three-dimensional configuration of points. The points can, for example, correspond to atoms, in which case the invariant or covariant descriptors can be used by machine learning models to predict physical properties of configurations of the atoms, e.g., energies or forces in atomic or molecular systems.

Invariant or covariant descriptors can be used to characterize configurations of points uniquely and independently of how the coordinate system that is used to define the locations of the points is oriented. In atomic/molecular systems, examples of rotationally invariant descriptors include bond lengths, which comprise 2-body information, and bond angles, which comprise 3-body and sometimes higher information. In general, to characterize different configurations of points uniquely, the descriptors of each configuration must incorporate sufficiently “high-order” geometric information about the configuration, i.e., the descriptors need to be functions of the (relative) positions of many points, e.g., n-body information is needed, where n>2, 3, 4, etc. Descriptors can be characterised in terms of a “body order” in which polynomials of order d are said to be of body order d+1 (this convention includes one point (e.g., atom) at the origin of the coordinate system in the count). Failure to include such information in the descriptors, can reduce the performance of machine learning models that use the descriptors to predict properties of the configuration of points, such as in atomistic simulations.

In one aspect, there is provided herein a method performed by one or more computers and for generating rotationally invariant or covariant descriptors of a three-dimensional configuration of points. The method comprises using coordinates of the points to determine a plurality of feature vectors. Each feature vector has a corresponding degree (l) and comprising a respective plurality of features (which may be referred to as “fundamental features”). Each feature is determined using a spherical harmonic function (Yₗ^{m}) of the degree (l) of the feature vector and a respective order (m) by linearly combining (e.g., summing) values of the spherical harmonic function evaluated at the respective coordinates of the points.

The method further comprises transforming each of the plurality of the feature vectors into a corresponding moment matrix (M_{a,b,l}). Each moment matrix 112 corresponds to a respective irreducible representation of the 3D rotation group in a direct sum representation of a tensor product of irreducible representations of the 3D rotation group. The method further comprises using the moment matrices to determine one or more invariant or covariant descriptors of the three-dimensional configuration of the points.

Conventionally, descriptors expressed using irreducible representations of the 3D rotation group can be determined using a Clebsch-Gordan operation that comprises determining the tensor (outer) product of two feature vectors and then forming linear combinations, defined by Clebsch-Gordan coefficients, of the elements of the tensor product to determine the elements of the irreducible representation. Such a process can be referred to as “coupling” the feature vectors to cause higher-order geometric information to be encoded in the irreducible representations.

For example, the tensor product can be of a first feature vector ( [symbol] ) of degree a with a respective second feature vector ( [symbol] ) of degree b (where a and b are integers), in which case, the tensor product [symbol] & [symbol] is a matrix of shape (2a+1)×(2b+1).

A direct sum representation of the tensor product can then comprise a direct sum of irreducible representations (which may be referred to as “irreps”), which may be denoted, [symbol] ⊕ [symbol] =(| [symbol] − [symbol] |)⊕ . . . ⊕( [symbol] + [symbol] ) where each of the irreducible representations (| [symbol] − [symbol] |), . . . , ( [symbol] + [symbol] ) is of shape (2a+1)×(2b+1) and corresponding degree, l=|a−b|, |a−b|+1, . . . , a+b. Each irreducible representation can be determined from linear combinations of the elements of the tensor product using Clebsch-Gordan coefficients. Thus, irreducible representations encoding higher-order geometric information can be obtained from feature vectors that comprise only 2-body information (i.e., depending on particle coordinates relative to an origin).

By contrast, the present method can avoid the need to form the tensor product of the feature vectors by determining irreducible representations as moment matrices from a single feature vector, and then combining (e.g., multiplying) different moment matrices to obtain the feature vectors that encode higher-order geometric information about the 3D configuration of points.

Each moment matrix (M_{a,b,l}) can be generated using a corresponding feature vector of the same degree/as the moment matrix, e.g., using a feature vector having respective features of degree m given by

$${Σ}_{{r}_{i}} {Y}_{l}^{m} ( {r}_{i} ) ,$$

where rᵢ are the coordinates (e.g., x, y, z coordinates) of a point labelled by an index i and the sum is over all of the points.

In some implementations, transforming each of the plurality of the feature vectors into a corresponding moment matrix comprises determining elements of the moment matrix using respective linear combinations of the features of the feature vector. For example, each of the linear combinations can comprise a sum of each of the features weighted by a respective coefficient that depends on the degree (l) of the corresponding feature vector and the respective order (m) of the feature. Each coefficient can be a Clebsch-Gordan coefficient, for example.

As one example, an element at position (m₁, m₂) in the moment matrix (M_{a,b,l}) can be obtained from a sum over the features of the corresponding feature vector in which each of the features of respective order m is weighted by a respective Clebsch-Gordan coefficient,

$${C}_{a , {m}_{1} , b , {m}_{2}}^{l , m} .$$

Clebsch-Gordan coefficients can be calculated using standard formulas and/or programming libraries. See, for example: “E3x:E(3)-Equivariant Deep Learning Made Easy” arXiv:2401.07595. As used herein, the term Clebsch-Gordan coefficient also includes other analogous coefficients, such as Wigner 3-j symbols and so forth, e.g., which may use a different phase convention or scaling factor.

In general, a descriptor can be a numerical value, or collection of numerical values (e.g., an ordered collection of numerical values), that characterizes a configuration of points, such as a configuration of the atoms/molecules in a chemical system. A rotationally invariant descriptor can refer to a scalar value determined from the coordinates of the points and which is unchanged when the coordinates are expressed in different coordinate systems that are related to one another by a rotation, e.g., an element of the 3D rotation group, SO(3). A rotationally covariant descriptor can be a vector or tensor determined from the coordinates of the points and which rotates “in the same way” as the coordinate system when the coordinate system is rotated. Invariant descriptors can be determined by taking a scalar (dot) product of two covariant vectors, for example.

In some implementations, using the moment matrices to determine the one or more invariant or covariant descriptors comprises multiplying two or more of the moment matrices and a vector comprising a linear combination of one or more of the feature vectors to obtain a corresponding invariant or covariant descriptor.

In some implementations, using the moment matrices to determine the one or more invariant or covariant descriptors comprises determining one or more combined moment matrices. Each combined moment matrix is determined using a respective linear combination of moment matrices that have the same shape as the combined moment matrix. For example, the moment matrices that have the same shape as the combined moment matrix can comprise moment matrices of different degrees (l). For example, the moment matrices that have the same shape as the combined moment matrix can comprise at least one moment matrix of each degree (l) in a range from |a−b| to (a+b), wherein the respective shape of the combined moment matrix is (2a+1)×(2b+1). The linear combination can be defined by learnable parameters, e.g., parameters that are adjusted during training of a machine learning model.

The method can then comprise using the combined moment matrices to determine the one or more invariant or covariant descriptors.

As one example, the one or more combined moment matrices can comprise one or more square matrices. Using the moment matrices to determine the one or more invariant or covariant descriptors can then comprise determining one or more invariant descriptors using respective traces of the one or more square matrices, e.g., using linear combinations of the respective traces of the one or more square matrices.

In some implementations, using the moment matrices to determine one or more invariant or covariant descriptors of the three-dimensional configuration of the points comprises determining a plurality of moment block matrices. Each moment block matrix can comprise a plurality of blocks (sub-matrices) that each comprise a respective one of the moment matrices or combined moment matrices. A moment block matrix may alternatively be referred to as a “matrix of matrices”.

The method can then comprise multiplying the plurality of moment block matrices and a feature block matrix comprising a linear combination of one or more of the feature vectors to obtain a corresponding invariant or covariant descriptor. Using moment block matrices can allow the invariant or covariant descriptors to be determined efficiently using one or more hardware accelerators optimized for matrix multiplication (i.e., of large matrices), such as Graphics Processing Units (GPUs) or Tensor Processing Units (TPUs). For example, by multiplying fewer, larger moment block matrices, the one or more hardware accelerators can determine invariant or covariant descriptors more quickly (e.g., as measured by wall-clock time) compared to separately multiplying products of the moment matrices or combined moment matrices to determine the invariant or covariant descriptors.

In some implementations, each moment block matrix can be updated (“shifted”) by adding the identify matrix (e.g., a scaled identity matrix) to the moment block matrix. This approach can allow for more efficient training (e.g., determining weight parameters for linear combinations of the feature vectors or moment matrices), even for large numbers of moment block matrices, e.g., in a similar way to skip connections in ResNets.

Corresponding blocks of each of the moment block matrices can have the same respective shapes. In other words, each of the moment block matrices can have the same block structure. In some implementations, each of the moment block matrices is a square matrix. Thus, products of the moment block matrices remain square and can fit into allocated memory.

In some implementations, the feature block matrix comprises a linear combination of a plurality of the feature vectors of the same degree (l).

In some implementations, the feature block matrix comprises a concatenation of feature blocks. Each feature block can comprise one or more rows or columns that each comprise a respective linear combination of feature vectors of the same degree (l). For example, weight parameters defining each linear combination can be learnable parameters of a machine learning model, e.g., a neural network.

In some implementations, multiplying the plurality of moment block matrices and the feature block matrix comprising one or more of the feature vectors to obtain a corresponding invariant or covariant descriptor can comprise: determining a further feature block matrix comprising a linear combination of a plurality of the feature vectors of the same degree (l); and multiplying (i) one or more covariant descriptors obtained by multiplying the plurality of moment block matrices and the feature block matrix, and (ii) the further feature block matrix (or a transpose thereof), to obtain a corresponding plurality of invariant descriptors.

In some implementations, using the moment matrices to determine the one or more invariant or covariant descriptors comprises: determining (i) one or more linear combinations of the feature vectors; and/or (ii) one or more linear combinations of the moment matrices, each linear combination being determined using a corresponding set of feature or moment matrix weight parameters (e.g., learnable parameters).

Optionally, the method further comprises adjusting the feature or moment matrix weight parameters to optimise an objective function that depends on the one or more invariant or covariant descriptors.

In some implementations, the method further comprises: determining one or more linear combinations of the invariant or covariant descriptors, each linear combination being determined using a corresponding set of descriptor weight parameters (e.g., learnable parameters), and adjusting the descriptor weight parameters to optimise an objective function that depends on the one or more linear combinations of the invariant or covariant descriptors.

In general, the method can further comprise processing the one or more invariant or covariant descriptors using a machine learning model to generate a corresponding model output. For example, the model output can be indicative of one or more physical properties of the configuration of points.

In some implementations, optimizing the objective function can comprise: obtaining a plurality of training data items. Each training data item can comprise (a) a training input comprising coordinates of a respective configuration of points and (b) a target output comprising one or more physical properties of the configuration of points. The method can comprise, for each of the training data items: determining a respective one or more invariant or covariant descriptors for the configuration of points of the training input; and processing the one or more invariant or covariant descriptors using the machine learning model to generate a corresponding model output for the configuration of points of the training input. The objective function can depend on a comparison (e.g., differences) between the model outputs and the corresponding target outputs. Thus, the generation of the descriptors can be optimized such that the performance of the machine learning model can be improved. In general, any suitable objective (or “loss”) function can be used depending on the model outputs and target outputs being compared, e.g., a least-squares objective function, a cross-entropy loss function, etc.

In some implementations, the descriptors may be generated by another machine learning model (e.g., a neural network) that is trained end-to-end with the machine learning model. For example, training the two models end-to-end can comprise backpropagating gradients of the objective function with respect to the learnable parameters through respective neural networks of the models.

In some implementations, the configuration of points can correspond to a configuration of atoms or molecules, with each point corresponding to a respective atom or molecule in the configuration of atoms or molecules.

In implementations, the descriptors can include radial functions (e.g., radial basis functions) to include radial information as well as angular information in the descriptor. As one example, Chebyshev polynomials can be used as radial functions, e.g., Chebyshev polynomials of the log radius.

In some examples, the method can be performed for a plurality of proper subsets of the atoms to generate, for each subset, one or more rotationally invariant or covariant descriptors of the respective configuration of atoms in the subset. For example, each subset may consist of atoms of the same respective type (e.g., a first subset consisting of carbon atoms, a second subset consisting of hydrogen atoms, and so on). In some implementations, the method can comprise multiplying moment matrices determined using feature vectors of different subsets of the atoms.

In some implementations, the descriptors 116 can include radial functions (e.g., radial basis functions) to include radial information as well as angular information in the descriptor. As one example, Chebyshev polynomials can be used as radial functions, e.g., Chebyshev polynomials of the log radius.

Particular embodiments of the subject matter described in this specification can be implemented so as to realize one or more of the following advantages.

The systems and methods described in this specification can be used to obtain rotationally invariant or covariant descriptors of spatial configurations (3D arrangements) of points in a more computationally efficient way than existing approaches that use Clebsch-Gordan operations (“coupling”) to generate descriptors from (higher-degree) feature vectors obtained from tensor products of (lower-degree) feature vectors.

For example, calculating descriptors by performing Clebsch-Gordan operations with feature vectors that have respective degrees spanning a wide range, e.g., from 0 to a maximum value (l), scales poorly, e.g., with a computational complexity of O(l⁶). By contrast, the methods described in this specification (“matrix multiplication”) can scale more favorably, e.g., with a computation complexity of O(l³). In particular, the present disclosure allows effective descriptors to be obtained without performing all the operations that would be needed to couple feature vectors by the (full) Clebsch-Gordan approach.

The improved scaling is particularly advantageous for generating descriptors of chemical systems (e.g., comprising atoms, ions and/or molecules) for use in molecular dynamics calculations, which typically require large numbers of descriptors to be generated at large number of time steps, e.g., molecular dynamics simulations of condensed phase systems. In this manner, the present systems and methods can enable more efficient use of computational resources.

As noted above, the methods described in this specification can also be implemented efficiently using block matrices and hardware accelerators, such as GPUs or TPUs.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example molecular property prediction system.

FIG. 2 shows body-orders needed to distinguish between example molecular configurations.

FIG. 3 shows an example set of moment matrices.

FIG. 4 shows an example of how multiplication of moment matrices can be used to obtain invariant or covariant descriptors.

FIG. 5 shows an example moment block matrix.

FIG. 6 is a flow diagram of an example process for generating rotationally invariant or covariant descriptors of a three-dimensional configuration of points.

Like reference numbers and designations in the various drawings indicate like elements.

### DETAILED DESCRIPTION

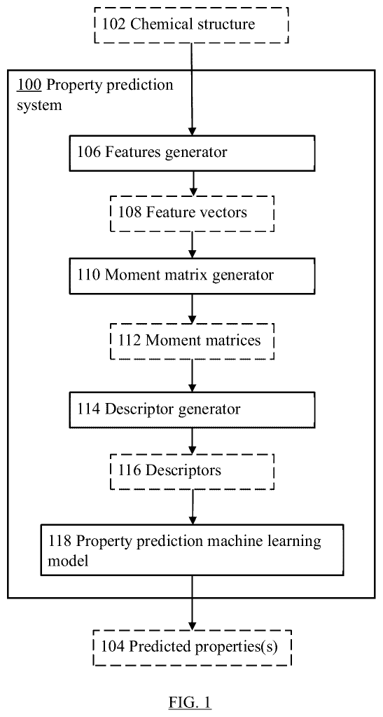

FIG. 1 shows an example molecular property prediction system 100. The molecular property prediction system 100 is an example of a system implemented as computer programs on one or more computers in one or more locations in which the systems, components, and techniques described below are implemented.

The system 100 is configured to process a chemical structure 102 defining a three-dimensional configuration of atoms or molecules to generate values of one or more predicted properties 104 of the chemical structure. As used herein, a chemical structure 102 can refer to any data defining any three-dimensional configuration of atoms or molecules. In general, the chemical structure 102 is received as, or converted into, a three-dimensional set of points defining locations of each atom or molecule the chemical structure. Each point in the set of points can have a respective one of a plurality of “colors” γ assigned to it, each color corresponding a different type of point, e.g., a type of atom or molecule. Expressed mathematically, each point rᵢϵ [symbol] ³ and is of color γᵢϵC (the set of colors) and i=1, . . . , n (the number of points), with the points of the same color forming a respective subset S_{γ} of the set of points S. It will be understood that references to color are merely for ease of explanation and that the term “color” is merely intended to represent labels for different sets of particles (e.g., atoms or molecules).

The system 100 comprises a features generator 106 configured to process the coordinates of the points in the chemical structure 102 to determine a plurality of feature vectors 108. Each feature vector has a corresponding degree (l) and comprises a respective one or more features. Each feature is determined using a spherical harmonic function (Yₗ^{m}) of the degree (l) of the feature vector and a respective order (m) by linearly combining values of the spherical harmonic function evaluated at the respective coordinates of the points.

The system 100 further comprises a moment matrix generator 110 configured to transform each of the plurality of the feature vectors 108 into a corresponding moment matrix 112. Each moment matrix 112 corresponds to a respective irreducible representation of the 3D rotation group, SO(3), in a direct sum representation of a tensor product of irreducible representations of the 3D rotation group. Each moment matrix 112 can be determined by applying the Clebsch-Gordon relation

$${ℋ}^{( a )} ⊗ {ℋ}^{( b )} ≅ {π}^{( \vert a - b \vert )} ⊕ {ℋ}^{( \vert a - b \vert + 1 )} ⊕ … ⊕ {ℋ}^{( a + b )}$$

“backwards” to encode features in [symbol] ^{(|a-b|)}⊕ [symbol] ^{(|a-b|+1)}⊕ . . . ⊕ [symbol] ^{(a+b)} as a (2a+1)×(2b+1) matrix, where each [symbol] ^{(l)} is an irreducible (2l+1)-dimensional (real) representation of the 3D rotation group.

For example, each moment matrix (for the atoms/molecules having color γ) can be defined by the formula:

$${M}_{a , b , l} ( γ ) = {ι}_{a , b , l} {\sum }_{r ∈ {S}_{γ}} {Y}_{l} ( r )$$

where the M_{a,b,l} is an (2a+1)×(2b+1) moment matrix 112 and ι_{a,b,l} is a transformation applied to (i.e., embedding of) the feature vector, i.e., ι_{a,b,l}: [symbol] ^{(l)}→Mat_{2a+1,2b+1}, is a mapping from the feature vector to the moment matrix 112.

FIG. 3 illustrates the moment matrices 312A-C, for the case a=b=1, i.e., 3×3 matrices. The moment matrices 312A-C M_{1,1,l} correspond to respective irreducible representations [symbol] ⁽⁰⁾, [symbol] ⁽¹⁾, [symbol] ⁽²⁾ of the 3D rotation group in a direct sum representation of a tensor product [symbol] ^{(a=1)}⊕ [symbol] ^{(b=1)} of irreducible representations of the 3D rotation group. The moment matrix 312A M_{1,1,0} that corresponds to [symbol] ⁽⁰⁾, is a diagonal matrix formed from a single value derived from the feature values, the moment matrix 312B M_{1,1,1}, corresponding to [symbol] ⁽¹⁾, is an antisymmetric matrix formed by three values derived from the feature values, and the the moment matrix 312C M_{1,1,2}, corresponding to [symbol] ⁽²⁾, is a traceless symmetric matrix formed by five values derived from the feature values.

Explicit formulae for the moment matrices 312A-C M_{1,1,l} can be expressed as (with the formulae being presented for a single point with a corresponding (x, y, z) coordinate for simplicity):

$${M}_{1 , 1 , 0} = ( \begin{matrix}1 & 0 & 0 \\ 0 & 1 & 0 \\ 0 & 0 & 1\end{matrix} )$$

$${M}_{1 , 1 , 1} = ( \begin{matrix}0 & - z & y \\ z & 0 & - x \\ - y & x & 0\end{matrix} )$$

$${M}_{1 , 1 , 2} = ( \begin{matrix}\frac{2 {x}^{2} - {y}^{2} - {z}^{2}}{3} & xy & xz \\ xy & \frac{2 {y}^{2} - {x}^{2} - {z}^{2}}{3} & yz \\ xz & yz & \frac{2 {z}^{2} - {x}^{2} - {y}^{2}}{3}\end{matrix} )$$

For a=b=2, i.e., 5×5 matrices, the corresponding moment matrices M_{2,2,l} are:

$${M}_{2 , 2 , 0} = ( \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1\end{matrix} )$$

$${M}_{2 , 2 , 1} = ( \begin{matrix}0 & 2 x & z & - y & 0 \\ - 2 x & 0 & y & z & 0 \\ - z & - y & 0 & x & - \sqrt{3} y \\ y & - z & - x & 0 & \sqrt{3} z \\ 0 & 0 & \sqrt{3} y & - \sqrt{3} z & 0\end{matrix} )$$

$${M}_{2 , 2 , 2} = ( \begin{matrix}\begin{matrix}- 2 {x}^{2} + \\ {y}^{2} + {z}^{2}\end{matrix} & 0 & 3 xy & 3 xz & - 2 \sqrt{3} yz \\ 0 & \begin{matrix}- 2 {x}^{2} + \\ {y}^{2} + {z}^{2}\end{matrix} & - 3 xz & 3 xy & \sqrt{3} ( {z}^{2} - {y}^{2} ) \\ 3 xy & - 3 xz & \begin{matrix}{x}^{2} - \\ 2 {y}^{2} + {z}^{2}\end{matrix} & 3 yz & \sqrt{3} xz \\ 3 xz & 3 xy & 3 yz & \begin{matrix}{x}^{2} + \\ {y}^{2} - 2 {z}^{2}\end{matrix} & \sqrt{3} xy \\ - 2 \sqrt{3} yz & \sqrt{3} ( {z}^{2} - {y}^{2} ) & \sqrt{3} xz & \sqrt{3} xy & 2 {x}^{2} - {y}^{2} - {z}^{2}\end{matrix} )$$

The moment matrices M_{2,2,i} are antisymmetric for odd i and can be written as Dᵢ−Dᵢ^{T}, while for even i, the moment matrices M_{2,2,i} are symmetric and can be written as Dᵢ+diag(dᵢ)+Dᵢ^{T}, with upper triangular matrices Dᵢ and diagonal matrices with entries dᵢ. Using r²=x²+y²+z², the remaining a=b=2 moment matrices 112 are:

$${D}_{2 , 2 , 3} = ( \begin{matrix}0 & 3 {r}^{2} x - 5 {x}^{3} & 10 {z}^{3} - 6 {r}^{2} z & 6 {x}^{2} y - 4 {y}^{3} + 6 {yz}^{2} & 5 \sqrt{3} ( {xz}^{2} - {xy}^{2} ) \\ 0 & 0 & - 6 {x}^{2} y - {y}^{3} + 9 {yz}^{2} & - 6 {x}^{2} z + 9 {y}^{2} z - {z}^{3} & 10 \sqrt{3} xyz \\ 0 & 0 & 0 & 10 {x}^{3} - 6 {r}^{2} x & \sqrt{3} ( {r}^{2} y - 6 {x}^{2} y ) \\ 0 & 0 & 0 & 0 & - \sqrt{3} ( {r}^{2} z - 5 {x}^{2} z ) \\ 0 & 0 & 0 & 0 & 0\end{matrix} )$$

$${D}_{2 , 2 , 4} = ( \begin{matrix}0 & 70 yz ( {y}^{2} - {z}^{2} ) & - 20 xy ( {r}^{2} - 7 {z}^{2} ) & - 20 xz ( {r}^{2} - 7 {y}^{2} ) & \begin{matrix}- 10 \sqrt{3} yz ( {r}^{2} - \\ 7 {x}^{2} )\end{matrix} \\ 0 & 0 & \begin{matrix}10 xz ( 2 {x}^{2} + \\ 9 {y}^{2} - 5 {z}^{2} )\end{matrix} & \begin{matrix}- 10 xy ( 2 {x}^{2} - \\ 5 {y}^{2} + 9 {z}^{2} )\end{matrix} & \begin{matrix}5 \sqrt{3} ( 6 {x}^{2} ( {y}^{2} - \\ {z}^{2} ) - {y}^{4} + {z}^{4} )\end{matrix} \\ 0 & 0 & 0 & - 20 yz ( {r}^{2} - 7 {x}^{2} ) & \begin{matrix}10 \sqrt{3} xz ( 7 {x}^{2} - \\ 3 {r}^{2} )\end{matrix} \\ 0 & 0 & 0 & 0 & \begin{matrix}10 \sqrt{3} xy ( 7 {x}^{2} - \\ 3 {r}^{2} )\end{matrix} \\ 0 & 0 & 0 & 0 & 0\end{matrix} )$$

$${d}_{4} = ( \begin{matrix}4 {x}^{4} - 12 {x}^{2} {y}^{2} - 12 {x}^{2} {z}^{2} - 16 {y}^{4} + 108 {y}^{2} {z}^{2} - 16 {z}^{4} \\ 4 {x}^{4} - 12 {x}^{2} {y}^{2} - 12 {x}^{2} {z}^{2} + 19 {y}^{4} - 102 {y}^{2} {z}^{2} + 19 {z}^{4} \\ - 16 {x}^{4} - 12 {x}^{2} {y}^{2} - 108 {x}^{2} {z}^{2} + 4 {y}^{4} - 12 {y}^{2} {z}^{2} - 16 {z}^{4} \\ - 16 {x}^{4} + 108 {x}^{2} {y}^{2} - 12 {x}^{2} {z}^{2} - 16 {y}^{4} - 12 {y}^{2} {z}^{2} + 4 {z}^{4} \\ 24 x - 72 {x}^{2} {y}^{2} - 72 {x}^{2} {z}^{2} + 9 {y}^{4} + 18 {y}^{2} {z}^{2} + 9 {z}^{4}\end{matrix} )$$

In general, an element at position (m₁, m₂) in the moment matrix M_{a,b,l} can be obtained from a sum over the features of the corresponding feature vector in which each of the features of respective order m is weighted by a respective Clebsch-Gordan coefficient,

$${C}_{a , {m}_{1} , b , {m}_{2}}^{l , m} .$$

Clebsch-Gordan coefficients can be calculated using standard formulas and/or programming libraries. See, for example: “E3x:E(3)-Equivariant Deep Learning Made Easy” arXiv:2401.07595.

The system 100 further comprises a descriptor generator 114 configured to process the moment matrices 112 to generate one or more invariant or covariant descriptors 116 of the three-dimensional configuration of the points.

The descriptor generator 114 can generate the descriptors 116 by multiplying the moment matrices 112. For example, two or more of the moment matrices can be used to multiply a vector comprising a linear combination of one or more of the feature vectors to obtain invariant or covariant descriptors.

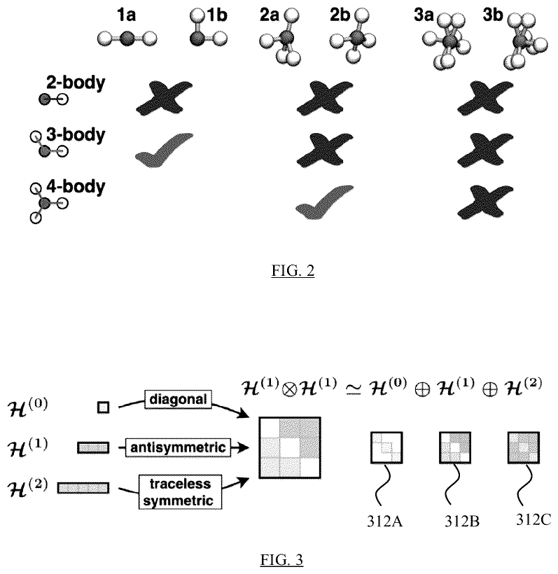

FIG. 2 shows examples for 3D configurations of chemical structures 1a, 1b, 2a, 2b, 3a, 3b that cannot be distinguished by descriptors constructed from 2-body information, 3-body information, and so on. From the perspective of the central black atom in each chemical structure, the surrounding chemical environments in examples 1a and 1b appear identical when considering only 2-body information (e.g., distances), but are readily distinguished by 3-body information (e.g., angles), while for examples 2a and 2b, 4-body information (e.g. dihedral angles) is needed. The chemical structures in examples 3a and 3b require even higher-order information to distinguish them. The system 100 can be used to generate higher-order descriptors 116 for distinguishing between different chemical structures and without the computational costs associated with existing methods. For example, structures 1a and 1b can be distinguished using respective invariant descriptor obtained by calculating

$$T r ( {M}_{1}^{2} ) ,$$

i.e., from the trace of a moment matrix M₁ (corresponding to [symbol] ⁽¹⁾) squared. Examples of invariant descriptors determined in similar ways for the various chemical structures in FIG. 2 are shown in the following table.

| invariant | 1a | 1b | 2a | 2b | 3a | 3b |
|---|---|---|---|---|---|---|
| Tr(M₀) | 4.47 | 4.47 | 8.94 | 8.94 | 15.7 | 15.7 |
| Tr(M₁²) | 0.0 | −2.0 | −1.067 | −1.067 | −1.859 | −1.859 |
| Tr(M₁ M₂ M₃) | 0.0 | −0.321 | −0.675 | 0.626 | 1.251 | 1.251 |
| Tr(M₁ M₃ M₄²) | 0.0 | −0.15 | −0.685 | 0.033 | 1.686 | 1.556 |

Ideal descriptors are unique, computationally efficient, and covariant. The system 100 can allow practical construction of provably complete system(s) of features with these desired properties that holds for any 3D point configurations.

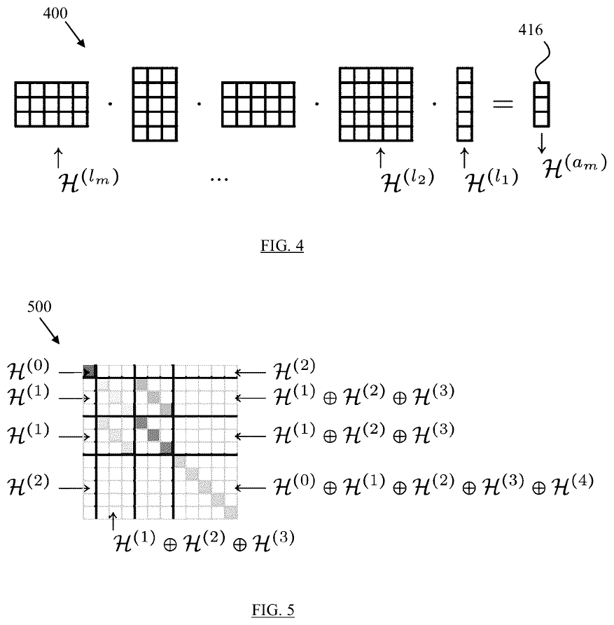

FIG. 4 illustrates an example of how multiplication of moment matrices 112 can be used to obtain invariant or covariant descriptors. In this example, the descriptors 416 are generated by a product 400 of moment matrices 112, which are each labelled in FIG. 4 by the corresponding irreducible representation [symbol] ^{(l)} of the 3D rotation group. In general, the matrix product 400 can be expressed as:

$${M}_{{a}_{m - 1} , {a}_{m} , {l}_{m}} ( {γ}_{m} ) \cdot … \cdot {M}_{{a}_{1} , {a}_{2} , {l}_{2}} ( {γ}_{2} ) \cdot {M}_{0 , {a}_{1} , {l}_{1}} ( {γ}_{1} )$$

in which l₁=a₁, and |a₁−a₂|≤l₂≤a₁+a₂, . . . |aₘ₋₁−aₘ|≤lₘ≤aₘ₋₁+aₘ, and which results in descriptors 416 that are covariant aₘ×1 matrices, i.e., vectors in [symbol] ^{(a}^{ₘ}⁾ given by polynomials of degree l₁+ . . . +lₘ. Computing the descriptors 416 takes [symbol] (m·a³) steps for an upper bound a≥aᵢ.

Returning to FIG. 1, the property prediction system 100 further comprises a property prediction machine learning model 118 that is configured to process a model input comprising the descriptors 116 to generate a model output comprising respective predicted values 104 of one or more properties of the chemical structure 102.

Any appropriate property prediction machine learning model 118 can be used. For example, the property prediction machine learning model 118 can comprise a neural network that has been trained to process descriptors to generate values of the one or more predicted properties. The neural network can include any appropriate types of neural network layers (e.g., fully connected layers, attention layers, convolutional layers, recurrent layers, and so forth) in any appropriate number (e.g., 3 layers, or 10 layers, or 50 layer) and connected in any appropriate configuration (e.g., as a directed graph of layers). In a particular example, the neural network can have a Transformer architecture, e.g., as described with reference to: Ashish Vaswani et al., “Attention is all you need,” Advances in Neural Information Processing Systems 30 (NIPS 2017).

The one or more physical properties can comprise, for example, one or more of: an energy of the configuration of atoms; a respective force on one or more of the atoms; an optical or spectroscopic property of the configuration of atoms; an electric, magnetic, or electromagnetic property of the configuration of atoms; an acoustic or mechanical property of the configuration of atoms. Some examples of such physical properties, include a formation energy (such as a free energy or enthalpy), a bandgap energy, a conductivity, or other electrical property (including e.g. superconductor properties, such as superconductor transition temperature); a magnetic property (e.g. permeability, Curie temperature); a mechanical property (e.g. bulk modulus, Young's modulus, density, ductility, strength, hardness); and a phase change property (e.g. a phase-change temperature, such as a melting or boiling point), and so on.

The property prediction machine learning model 118 can, for example, be trained to predict the values 104 of the one or more properties using a supervised learning method. For example, the property prediction machine learning model 118 can be trained using a plurality of training data items that each comprise a training input comprising a respective set of descriptors for a 3D configuration of atoms or molecules, determined using moment matrices 112 as described above, and a respective target output comprising target values of the one or more properties for the 3D configuration of atoms or molecules. The target values can, for example, be determined for the 3D configuration of atoms or molecules by performing a respective (e.g., ab initio) quantum chemical calculation for the configuration of atoms, e.g., a Density Functional Theory (DFT) or coupled cluster (e.g., CCSD) calculation. Alternatively, or additionally, the target values can be obtained from experimental data, such as spectroscopic or thermochemical experimental data.

FIG. 5 shows an example moment block matrix 500 (or “matrix of matrices”) that comprises a plurality of blocks that each comprise a respective one of the moment matrices 112 or combination of moment matrices. This matrix can be applied to column vectors from [symbol] ^{(l}^{₁}⁾⊕ [symbol] ^{(l}^{₂}⁾⊕ . . . ⊕ [symbol] ^{(l}^{ᵣ}⁾ to generate covariant descriptors.

For many practical applications it is important to organize the matrix multiplications efficiently. In particular, when using hardware accelerators such as GPUs/TPUs with hardware support for matrix multiplication, it can be more favorable to compute with a few large matrices, such as the moment block matrix 500, than with many small matrices.

The moment block matrix 500 can be constructed using linear combinations of M_{a,b,l}(γ) for l=|a−b|, . . . , a+b to fill respective (2a+1)×(2b+1) matrices, and then packing r×r of these matrices for a, b in {l₁, l₂, . . . , lᵣ} into a larger square matrix of side length (2l₁+1)+ . . . +(2lᵣ+1) to form the moment block matrix 500. Traces of the square matrices correspond to components in [symbol] ⁽⁰⁾.

Multiplying k−1 such block matrices 500 matrices generates a matrix built out of covariant descriptors of body order k. This matrix can then be applied to n1 column vectors from [symbol] ^{(l}^{₁}⁾⊕ [symbol] ^{(l}^{₂}⁾⊕ . . . ⊕ [symbol] ^{(l}^{ᵣ}⁾ to generate covariant vectors of body order k+1. Scalar descriptors (invariants) can be obtained by taking scalar products of the n1 column vectors in [symbol] ^{(l}^{₁}⁾ with n₂ new covariants of body order k.

This approach can be incorporated into machine learning architectures to achieve significant efficiency gains compared to existing techniques that are dependent on Clebsch-Gordon operations, [symbol] ^{(l}^{₁}⁾⊕ [symbol] ^{(l}^{₂}⁾→ [symbol] ^{(l}^{₃}⁾. Some implementations can use a deep neural network instead of a linear combination of invariants or can use nonlinear activation functions to modify the matrices obtained in intermediate steps. For existing architectures that use several layers of Clebsch-Gordon operations, activation functions are restricted to functions of the scalar channel (as a transcendental function cannot be applied to a vector). However, any analytic function applied to (2l+1)×(2l+1) matrices generated by the present method (not element wise, but e.g., defined by a Taylor series for matrices) is also a covariant operation. This property means that analytic functions such as matrix exponentiation can be incorporated into neural network architectures that process the descriptors.

More generally, as the present methods can use the descriptors to generate complete representation of 3D configurations of points, the descriptors can allow (e.g., molecular) all types of configurations to be distinguished in a computationally efficient manner.

One exemplary algorithm for determining invariant descriptors now follows. The inputs to the algorithm comprise respective coordinates (points), such as for each of a plurality of atoms in a chemical system. Each point can have a respective one of a plurality of “colors” γ assigned to it (e.g., corresponding to atom type). In mathematical notation, each point rᵢϵ [symbol] ³ and is of color γᵢϵC (the set of colors) and i=1, . . . , n (the number of points).

Hyperparameters for the algorithm include: the number of vectors for scalar products (n_{vec}); the number of matrix products (nₘₐₜ); integers 0≤l₁≤ . . . ≤lᵣ, corresponding to matrix sides 2lᵢ+1 of sub-matrices; for i=1 . . . nₘₐₜ: integers bᵢ≥0 (corresponding to body orders bᵢ+2).

The algorithm comprises:

Step 1: Spherical harmonics: For l = 0, ... , 2l: for each color γ, determine Yₗ(γ) =
Εᵣₑₛ_{_{γ}}Yₗ(r), where S_{γ} is the set of points of for the color γ.
Step 2: Vectors: For i = 1, ... , r, compute 2 · nₘₐₜ · n_{vec} linear combinations of the
Yₗ_{ᵢ}(γ).
Step 3: Matrices: For (a, b) ∈ {l₁, ... , lᵣ}², compute b₁, ... , bₙ_{ₘₐₜ} matrices of shape a × b
by linear combinations of l_{a,b,l}(Yₗ(γ)) for l = |a − b|, ... , a + b. Assemble them to
b₁, ... , bₙ_{ₘₐₜ} square matrices.
Step 4: Products: For i = 1, ... , nₘₐₜ: assemble n_{vec} column vectors from step 2 into a
matrix V, use matrices from step 3 to compute products W = M₁ · M_{b}_{ᵢ} · V. Take all scalar
products of irreducible parts of columns of W with vectors from step 2, which gives nₘₐₜ.
$r \cdot {n}_{vec}^{2} invariants , which can be output as a linear combination .$

The algorithm can, for example, be implemented in the Python programming language using the E3x library (“E3x:E(3)-Equivariant Deep Learning Made Easy” arXiv:2401.07595) as shown in the following code listing, which is for one matrix product and one color for simplicity:

```
from e3x.matrix import matmat
from e3x.so3 import irreps
from jax import numpy as jnp
def f(params, conf, max_degree, ls, mult, n_factors, shift_by_id):
  “““Function approximation by matrix products.
  Args:
```

| | |
|---|---|
| params: | List of parameters. |
| conf: | Configuration of points. |
| l_max: | Maximal degree (L) of irreducibles in the matrices. |
| ls: | List of L's for the submatrices. |
| mult: | Multiplicity of each L. |

```
    n_factors: Number of factors in matrix products.
    shift_by_id: Shift matrix multiplication by identity matrix.
  Returns:
    Estimated function.
  ”””
  sh = irreps.spherical_harmonics(conf, max_degree=max_degree)
```

| | |
|---|---|
| sum_sh = jnp.sum(sh, axis=1) | # [shells, (L+1)\hat{ }2] |
| sh_features = jnp.transparent(sum_sh) | # [(L+1)\hat{ }2, shells] |

```
  primary_features = matmat.combine_irreps(sh_features, params[0], ‘high’)
  product = matmat.make_square_matrix(primary_features, ls, mult, max_degree,
```

shift_by_id, ‘high’)

```
  for i in range(1, n_factors):
    primary_features = matmat.combine_irreps(sh_features, params[i], ‘highs’)
    matrix_features = matmat.make_square_matrix(primary_features, ls, mult,
```

max_degree, shift_by_id, ‘high’)

```
    product = jnp.matmul(product, matrix_features, precision=‘high’)
  prod_traces = matmat.get_traces(products, ls, mult, shift_by_id)
  result = jnp.dot(prod_traces, params[−1], precision=‘high’)
  return result
  def init_params(
      key, ls, mult, max_degree, n_shells, n_factors,
        factor_mat, factor_final
    ):
      keys = jax.random.split(key, n_factors + 1)
      dict_irreds = matmat.make_dict_irrps_mult(ls, max_1 = max_degree)
      init = matmat.init_mat_irreds_weights
      params = |
        init(keys[i], n_shells, dict_irreds, mult, factor_mat)
        for i in range(n_factos)
      ]
      params.append(
        jax.random.normal(keys[-1], (len(ls) * mult**2,)) * factor_final
      )
      return params
```

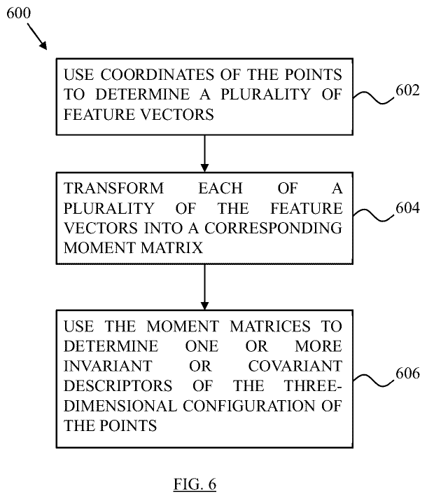

FIG. 6 is a flow diagram of an example process 600 for generating rotationally invariant or covariant descriptors of a three-dimensional configuration of points. For convenience, the process 600 will be described as being performed by a system of one or more computers located in one or more locations. For example, a property prediction system, e.g., the property prediction system 100 of FIG. 1, appropriately programmed in accordance with this specification, can perform the process 600.

The system uses (step 602) coordinates of the points to determine a plurality of feature vectors. Each feature vector has a corresponding degree (l) and comprises a respective one or more features. Each feature is determined using a spherical harmonic function (Y) of the degree (l) of the feature vector and a respective order (m) by linearly combining values of the spherical harmonic function evaluated at the respective coordinates of the points.

The system then transforms (step 604) each of a plurality of the feature vectors into a corresponding moment matrix, M_{a,b,l}. Each moment matrix corresponds to a respective irreducible representation ( [symbol] ^{(l)}) of the 3D rotation group in a direct sum representation ( [symbol] ^{(|a-b|)}⊕ [symbol] ^{(|a-b|+1)}⊕ . . . ⊕ [symbol] ^{(a+b)}) of a tensor product of irreducible representations ( [symbol] ^{(a)}⊕ [symbol] ^{(b)}) of the 3D rotation group.

The system then uses (step 606) the moment matrices to determine one or more invariant or covariant descriptors of the three-dimensional configuration of the points.

The systems and methods described in this specification can be used in a variety of different fields.

For example, the predicted properties 104 of the chemical structure 102 determined by the system 100 can be used for a number of chemical or biochemical applications. For example, some applications can comprise selecting a chemical structure from a plurality of candidate chemical structures based on respective predicted properties 104 generated by the system 100 for each of the candidate chemical structures. For example, selecting the chemical structure can comprise performing respective molecular dynamics calculations for each of the candidate chemical structures. At each of a plurality of time steps after a first time step, coordinates of the atoms in the candidate chemical structure are updated based on one or more model outputs generated by the machine learning model at one or more preceding time steps. For example, the machine learning model can be trained to predict a respective force on each of the atoms and use the forces to update the coordinates of the atoms.

As one particular example, the selected chemical structure can be a drug or a ligand of an industrial enzyme. Selecting the chemical structure from the plurality of candidate chemical structures can comprise evaluating an interaction of each candidate chemical structure with a target molecule and/or binding site of a target molecule (e.g., a protein or nucleic acid, such as DNA or RNA). As one example, the target molecule and/or binding site of the target molecule can comprise a receptor or enzyme, and the selected chemical structure can be an agonist or antagonist of the receptor or enzyme.

A “ligand” can refer to a molecule or other compound that is capable of binding to and forming a complex with a target molecule, e.g., a protein. Ligands can include, e.g., small organic compounds, macromolecules, and so forth. A ligand may associate or interact (e.g., through chemical bonds, or hydrogen bonds, or Van der Waals forces, or hydrophobic interaction, or electrostatic interaction, and so forth) to form a joint structure with the target molecule. In some implementations the ligand(s) may include small molecule complex ligands, e.g., organic compounds with a molecular weight of <900 daltons. In some other implementations the candidate ligand(s) may include polypeptide ligands, i.e., defined by an amino acid sequence. In some implementations, the ligand is a polypeptide ligand, a polynucleoside ligand, or a polynucleotide ligand.

In some implementations, evaluating the interaction may include evaluating binding of the candidate ligand with the structure of the target molecule (such as a biological molecule). For example, evaluating the interaction may include identifying a ligand that binds with sufficient affinity for a biological effect. In some other implementations, evaluating the interaction may include evaluating an association of the candidate ligand with the target molecule which has an effect on a function of the target molecule, e.g., an enzyme. The evaluating may include evaluating an affinity between the candidate ligand and the target molecule or complex, or evaluating a selectivity of the interaction. The candidate ligand(s) may be selected according to which have the highest affinity. Evaluating the interaction may additionally comprise simulating a dynamical behavior of the ligand and target molecule, such as through molecular dynamics simulations, which may allow kinetic aspects of the interaction to be taken into account.

The evaluation of the interaction of a candidate ligand with the target molecule may be performed using a computer-aided approach in which graphical models of the candidate ligand and target molecule structure are displayed for user-manipulation, and/or the evaluation may be performed partially or completely automatically, for example using standard molecular (e.g. protein-ligand) docking software. In some implementations the evaluation may include determining an interaction score for the candidate ligand, where the interaction score includes a measure of an interaction between the candidate ligand and the target molecule. The interaction score may be dependent upon a strength and/or specificity of the interaction, e.g., a score dependent on binding free energy. A candidate ligand may be selected dependent upon its score.

In some implementations the target molecule includes a receptor or enzyme and the ligand is an agonist or antagonist of the receptor or enzyme. In some implementations the method may be used to identify the structure of a cell surface marker. This may then be used to identify a ligand, e.g., an antibody or aptamer or a label such as a fluorescent label, which binds to the cell surface marker. This may be used to identify and/or treat cancerous cells.

In some implementations the ligand is a drug and the interaction of each of a plurality of target molecules (such as a biological molecule) with each of the candidate ligands is evaluated. Then one or more of the candidate ligands may be selected either to obtain a ligand that (functionally) interacts with each of the target molecules, or to obtain a ligand that (functionally) interacts with only one of the target molecules. For example in some implementations it may be desirable to obtain a drug that is effective against multiple drug targets. Also or instead, it may be desirable to screen a drug for off-target effects. For example, in agriculture it can be useful to determine that a drug designed for use with one plant species does not interact with another, different plant species and/or an animal species.

As another example, the selected chemical structure can be a drug, and selecting the chemical structure from the plurality of candidate chemical structures can comprise: evaluating an interaction of each candidate chemical structure with each of a plurality of target molecules and/or binding sites of target molecules to either (i) obtain a chemical structure that interacts with each of the target molecules and/or binding sites, or (ii) obtain a chemical structure that interacts with only one of the target molecules and/or binding sites of the target molecules.

As a further example, the selected chemical structure can be a catalyst of an industrial chemical process and the one or more physical properties comprise one or more measures or predictors of catalytic activity of the selected chemical structure for the industrial chemical process (e.g., rate coefficients, binding energies, binding lifetimes, diffusion constants, etc.).

In some examples, the selected chemical structure (and/or each of the candidate chemical structures) can be an inorganic compound (e.g., a ceramic, a superconductor, an organometallic compound, and so on), or an alloy.

In some implementations, the method further comprises synthesizing the ligand. The biological activity of the ligand may then be tested in vitro and/or in vivo. For example the ligand may be tested for ADME (absorption, distribution, metabolism, excretion) and/or toxicological properties, to screen out unsuitable ligands. The testing may include, e.g., bringing the candidate small molecule, polypeptide or polynucleotide ligand into contact with the target molecule (e.g. protein) and measuring a change in expression or activity of the target molecule.

Although the systems 100 and methods in this specification have generally been described in terms of predicting properties of chemical structures, it will be appreciated that analogous systems can be used for many other application. For example, in other implementations, each of the points can correspond to a respective location in an environment (e.g., a real-world environment) and the method further comprises determining coordinates of each of the points from one or more images of the environment, e.g. obtained using one or more image sensors. For example, each image can comprise a plurality of pixels, each pixel having an associated set of one or more pixel values. Determining coordinates of each of the points from one or more images of the environment can comprise processing the pixel values. For example, each set of one or more pixel values can comprise a respective depth value for the corresponding pixel. Thus, in some examples, the one or more images can comprise one or more point clouds of the environment.

Descriptors determined using the system and method may be used for a wide variety of applications, including scene classification, object recognition or localization, action or gesture recognition, semantic segregation, image generation, control of a mechanical agent or robot, and so on. As one example, the descriptors can be used predict or simulate future properties of the environment, such as future configurations of the environment.

For example, in some implementations, the machine learning model is used to perform one or more of:
(i) a classification task, wherein the model output classifies the environment into one or more categories;
(ii) an object recognition or localization task, wherein the model output is indicative of whether one or more objects is present in the environment or the model output defines coordinates of a respective region for one or more objects in the environment;
(iii) an action or gesture recognition task, wherein the model output is indicative of whether one or more actions or gestures is being performed in the environment;
(iv) a semantic segmentation task, wherein the model output assigns spatial locations in the environment to respective segmentation categories;
(v) a keypoint detection task, wherein the model output comprises coordinates of one or more keypoints in the environment; and
(vi) an environment similarity task, wherein the model output is indicative of a similarity of the environment to one or more predetermined environments.

In some implementations, the environment can be a real-world environment and the agent comprises (i) a mechanical agent or robot interacting with the real-world environment to perform the specified task, or (ii) an electronic agent controlling items of equipment in the real-world environment to perform the specified task. The coordinates of the points can, for example, be obtained by processing sensor data obtained by one or more sensors in the real-world environment, e.g., one or more sensors on the mechanical agent or robot.

The method can then comprise providing the instructions or control signals to the mechanical or electronic agent. In some examples, the method can comprise processing sensor data obtained by one or more sensors in the real-world environment (e.g., sensors of the mechanical agent or robot) to determine descriptors characterizing the environment based on coordinates of points extracted from the sensor data. In some implementations, the descriptors can be provided as an input to a policy machine learning model (e.g., a policy neural network) that processes the updated representation in accordance with parameters of the policy machine learning model to determine an output comprising an action to be performed by the mechanical or electronic agent.

In some examples, the descriptors can be processed to determine an expected return for the one or more actions, e.g., using an action-value machine learning model (e.g. a Q-function neural network).

As a more particular example, the descriptors may be used to provide an input to a control system of a mechanical agent, such as a robot or vehicle operating in a real-world environment. The control system may provide an output that controls the operation of the robot or vehicle to perform a task such as manipulating an object in the environment or moving in the environment. The descriptors may be used to, e.g., detect objects for the robot to manipulate, or obstacles or paths upon which the mechanical agent can move, and may be used by the control system e.g. to make decisions on how to accomplish a task performed by the robot, or for controlling the direction or speed of movement of the agent.

The agent can be a mechanical agent, e.g., a robot or vehicle, controlled to perform actions in the real world environment, in response to the observations, to perform the task, e.g. to manipulate an object or to navigate in the environment. Thus the agent can be, e.g., a real-world or simulated robot; as some other examples the agent can be a control system to control one or more machines or items of equipment in an industrial facility.

In cases where the environment is a virtual environment, the descriptors may be used to train the agent to perform the task in the virtual environment. The trained agent may then be used to perform the task in a real-world environment. Such a procedure may be referred to as “sim-to-real” training.

The real-world (physical) environment can be any appropriate environment, e.g., a real-world physical environment, e.g., a manufacturing environment, a warehouse environment, a roadway environment, and so forth. The physical environment can include one or more agents that interact with the environment, e.g., robotic agents, vehicles, and so forth. The physical environment can include any of a variety of objects, e.g., tools, packages, mechanical parts, electrical parts, walls, floors, roadway surfaces, conveyor belt surfaces, and so forth. In some implementations, the above-described systems and methods may be used for real-world control, in particular optimal control tasks, e.g., to assist a robot in manipulating a deformable or rigid object. Thus, the physical environment may comprise a real-world environment including a physical object e.g., an object to be picked up or manipulated. The descriptors can be used to generate a representation of the physical environment at the current or one or more other (e.g., previous) time steps, and may e.g., define a representation of a shape or configuration of the physical object at the time step. The representation of the physical environment at the new time step may define a predicted representation of the shape or configuration of the physical object e.g., when subject to a force or deformation e.g., from an actuator of a robot. The method may further comprise controlling the robot using the predicted representation to manipulate the physical object, e.g., using the actuator, towards a target location, shape or configuration of the physical object by controlling the robot to optimize an objective function dependent upon a difference between the predicted representation and the target location, shape or configuration of the physical object. Controlling the robot may involve providing control signals to the robot based on the predicted representation to cause the robot to perform actions, e.g., using an actuator of the robot, to manipulate the physical object to perform a task. For example this may involve controlling the robot, e.g., the actuator, using a reinforcement learning process with a reward that is at least partly based on a value of the objective function, to learn to perform a task which involves manipulating the physical object.

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations may include, e.g., one or more of: images, object position data, and sensor data to capture observations as the agent interacts with the environment. The actions may define control signals to control the robot or other mechanical agent, e.g., positions, torques, or other control signals for the parts of the mechanical agent, or higher-level control commands.

In some examples, the points may be keypoints identified in one or more images, that may e.g. define landmarks of an object represented in the image. Thus, the descriptors can be used to generate a representation characterizing an object based at least in part on its keypoints. The representation can then be processed by a machine learning model to perform a machine learning task, such as classifying the object according to one or more predefined classes, 3D pose estimation, and so on.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them. Thus a system, artificial neural network, or trained artificial neural network as described herein, can be implemented in hardware using electronic circuitry, e.g., in a physical box. Similarly computer code as described herein can be code to emulate such hardware or code for a hardware description language.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers and for generating rotationally invariant or covariant descriptors of a three-dimensional configuration of points, the method comprising:
using coordinates of the points to determine a plurality of feature vectors, each feature vector having a corresponding degree (l) and comprising a respective one or more features, each feature being determined using a spherical harmonic function
$$( {Y}_{l}^{m} )$$
of the degree (l) of the feature vector and a respective order (m) by linearly combining values of the spherical harmonic function evaluated at the respective coordinates of the points;
transforming each of the plurality of the feature vectors into a corresponding moment matrix (M_{a,b,l}), wherein each moment matrix corresponds to a respective irreducible representation ( [symbol] ^{(l)}) of the 3D rotation group in a direct sum representation ( [symbol] ^{(|a-b|)}⊕ [symbol] ^{(|a-b|+1)})⊕ . . . ⊕ [symbol] ^{(a+b)}) of a tensor product of irreducible representations ( [symbol] ^{(a)}⊕ [symbol] ^{(b)}) of the 3D rotation group; and
using the moment matrices to determine one or more invariant or covariant descriptors of the three-dimensional configuration of the points.

2. The method of claim 1, wherein transforming each of the plurality of the feature vectors into a corresponding moment matrix comprises determining elements of the moment matrix using respective linear combinations of the features of the feature vector.

3. The method of claim 1, wherein each of the moment matrices is the irreducible representation of the 3D rotation group having the degree (l) of the corresponding feature vector and has a respective shape (2a+1)×(2b+1), wherein a and b are selected such that the degree (l) of the corresponding feature vector is in a range from |a−b| to (a+b).

4. The method of claim 1, wherein using the moment matrices to determine the one or more invariant or covariant descriptors comprises:
multiplying two or more of the moment matrices and a vector comprising a linear combination of one or more of the feature vectors to obtain a corresponding invariant or covariant descriptor.

5. The method of claim 1, wherein using the moment matrices to determine the one or more invariant or covariant descriptors comprises:
determining one or more combined moment matrices, each combined moment matrix being determined using a respective linear combination of moment matrices that have the same shape as the combined moment matrix; and
using the combined moment matrices to determine the one or more invariant or covariant descriptors.

6. The method of claim 5, wherein the moment matrices that have the same shape as the combined moment matrix comprise moment matrices of different degrees (l).

7. The method of claim 6, wherein the moment matrices that have the same shape as the combined moment matrix comprise at least one moment matrix of each degree (l) in a range from |a−b| to (a+b), wherein the respective shape of the combined moment matrix is (2a+1)×(2b+1).

8. The method of claim 5, wherein the one or more combined moment matrices comprise one or more square matrices and using the moment matrices to determine the one or more invariant or covariant descriptors comprises:
determining one or more invariant descriptors using respective traces of the one or more square matrices.

9. The method of claim 1, wherein using the moment matrices to determine one or more invariant or covariant descriptors of the three-dimensional configuration of the points comprises:
determining a plurality of moment block matrices, each moment block matrix comprising a plurality of blocks that each comprise a respective one of the moment matrices or combined moment matrices; and
multiplying the plurality of moment block matrices and a feature block matrix comprising a linear combination of one or more of the feature vectors to obtain a corresponding invariant or covariant descriptor.

10. The method of claim 9, wherein the feature block matrix comprises a linear combination of a plurality of the feature vectors of the same degree (l).

11. The method of claim 9, wherein the feature block matrix comprises a concatenation of feature blocks, each feature block comprising one or more rows or columns that each comprise a respective linear combination of feature vectors of the same degree (l).

12. The method of claim 9, wherein multiplying the plurality of moment block matrices and a feature block matrix comprising one or more of the feature vectors to obtain a corresponding invariant or covariant descriptor comprises:
determining a further feature block matrix comprising a linear combination of a plurality of the feature vectors of the same degree (l); and
multiplying (i) one or more covariant descriptors obtained by multiplying the plurality of moment block matrices and the feature block matrix, and (ii) the further feature block matrix, to obtain a corresponding plurality of invariant descriptors.

13. The method of claim 1, wherein using the moment matrices to determine the one or more invariant or covariant descriptors comprises:
determining (i) one or more linear combinations of the feature vectors; and/or (ii) one or more linear combinations of the moment matrices, each linear combination being determined using a corresponding set of feature or moment matrix weight parameters.

14. The method of claim 13, wherein the method further comprises:
adjusting the feature or moment matrix weight parameters to optimise an objective function that depends on the one or more invariant or covariant descriptors.

15. The method of claim 1 wherein the method further comprises:
determining one or more linear combinations of the invariant or covariant descriptors, each linear combination being determined using a corresponding set of descriptor weight parameters, and
adjusting the descriptor weight parameters to optimise an objective function that depends on the one or more linear combinations of the invariant or covariant descriptors.

16. The method of claim 14, further comprising processing the one or more invariant or covariant descriptors using a machine learning model to generate a corresponding model output.

17. The method of claim 16, wherein optimizing the objective function comprises:
obtaining a plurality of training data items, each training data item comprising (a) a training input comprising coordinates of a respective configuration of points and (b) a target output comprising one or more physical properties of the configuration of points;
for each of the training data items:
determining a respective one or more invariant or covariant descriptors for the configuration of points of the training input; and
processing the one or more invariant or covariant descriptors using the machine learning model to generate a corresponding model output for the configuration of points of the training input; and
wherein the objective function depends on a comparison between the model outputs and the corresponding target outputs.

18. The method of claim 16, wherein the configuration of points corresponds to a configuration of atoms, each point corresponding to a respective atom in the configuration of atoms, and further comprising performing the method for a plurality of proper subsets of the atoms to generate, for each subset, one or more rotationally invariant or covariant descriptors of the respective configuration of atoms in the subset.

19. A system comprising:
one or more computers; and
one or more storage devices communicatively coupled to the one or more computers, wherein the one or more storage devices store instructions that, when executed by the one or more computers, cause the one or more computers to perform operations for generating rotationally invariant or covariant descriptors of a three-dimensional configuration of points, the operations comprising:
using coordinates of the points to determine a plurality of feature vectors, each feature vector having a corresponding degree (l) and comprising a respective one or more features, each feature being determined using a spherical harmonic function (Yₗ^{m}) of the degree (l) of the feature vector and a respective order (m) by linearly combining values of the spherical harmonic function evaluated at the respective coordinates of the points;
transforming each of the plurality of the feature vectors into a corresponding moment matrix (M_{a,b,l}), wherein each moment matrix corresponds to a respective irreducible representation ( [symbol] ^{(l)}) of the 3D rotation group in a direct sum representation ( [symbol] ^{(|a-b|)}⊕ [symbol] ^{(|a-b|+1)}⊕ . . . ⊕ [symbol] ^{(a+b)}) of a tensor product of irreducible representations ( [symbol] ^{(a)}⊕ [symbol] ^{(b)}) of the 3D rotation group; and
using the moment matrices to determine one or more invariant or covariant descriptors of the three-dimensional configuration of the points.

20. One or more non-transitory computer storage media storing instructions that when executed by one or more computers cause the one or more computers to perform operations for generating rotationally invariant or covariant descriptors of a three-dimensional configuration of points, the operations comprising:
using coordinates of the points to determine a plurality of feature vectors, each feature vector having a corresponding degree (l) and comprising a respective one or more features, each feature being determined using a spherical harmonic function (Yₗ^{m}) of the degree (l) of the feature vector and a respective order (m) by linearly combining values of the spherical harmonic function evaluated at the respective coordinates of the points;
transforming each of the plurality of the feature vectors into a corresponding moment matrix (M^{a,b,l}), wherein each moment matrix corresponds to a respective irreducible representation ( [symbol] ^{(l)}) of the 3D rotation group in a direct sum representation ( [symbol] ^{(|a-b|)}⊕ [symbol] ^{(|a-b|+1)}⊕ . . . ⊕ [symbol] ^{(a+b)}) of a tensor product of irreducible representations ( [symbol] ^{(a)}⊕ [symbol] ^{(b)}) of the 3D rotation group; and
using the moment matrices to determine one or more invariant or covariant descriptors of the three-dimensional configuration of the points.
